(19) United States
(12) Patent Application Publication
(10) Pub. No.: US 2018/0103800 A1
(43) Pub. Date: Apr. 19, 2018

(54) COOKWARE WITH ATTACHED MULTIPURPOSE RECEPTACLE ASSEMBLY

(71) Applicant: Brian Bischoff, North Tonawanda, NY (US)

(72) Inventor: Brian Bischoff, North Tonawanda, NY (US)

(21) Appl. No.: 15/296,110

(22) Filed: Oct. 18, 2016

(51) Int. Cl. A47J 37/10

(52) U.S. Cl. CPC A47J 37/10; A47J 37/108

(57) ABSTRACT

A cookware with attached receptacle assembly provides cookware that is configured for cooking foodstuff, and at least one receptacle that fixedly or detachably attaches along the sidewall of the cookware providing multiple functions in conjunction with the cookware, including: manipulating foodstuff, preparing foodstuff, cooking at least a portion of foodstuff, warning and catching foodstuff residue, or combinations thereof. The cookware comprises an internal chamber defined by a base. The base has an exterior surface that engages a heat source and an interior surface for cooking foodstuff. The internal chamber is surrounded by a circumferential cookware sidewall terminating at an upper free edge. The receptacle either fixedly or detachably joins the cookware operating in conjunction with the cookware to prepare and cook foodstuff, along with containing foodstuff residue. The receptacle has a continuous receptacle wall that forms a cavity and terminates at a receptacle edge. The receptacle is wide or narrow.

### FIELD OF THE INVENTION

The present invention relates generally to cookware with attached multipurpose receptacle assembly. More so, the present invention relates to a cook-related assembly that provides a cookware, such as a frying pan, having an attached receptacle joined to a sidewall of the cookware for manipulating foodstuff, preparing foodstuff, cooking a portion of the foodstuff, catching residue from the foodstuff, or combinations thereof.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, cookware is a type of food preparation containers, commonly found in a kitchen. Cookware comprises cooking vessels, such as saucepans, bowls and frying pans, intended for use on a stove, table/countertops, or range cook top. Bakeware comprises cooking vessels intended for use inside an oven. Some utensils are considered both cookware and bakeware.

Generally, a frying pan has a flat bottom, a side extended around the flat bottom, and a handle fixedly fastened to the side. When cooking, edible oil is often poured onto the flat bottom, and then eggs, vegetable, fish, meat, etc. are put in the pan and fried.

Generally, eggs have an egg yolk and egg white contained in an egg shell. Eggs store significant amounts of protein and choline, and are widely used in cookery. Due to the protein content of eggs, the United States Department of Agriculture categorizes eggs as meats. Despite the nutritional value of eggs, there are some potential health issues arising from egg quality, storage, and individual allergies. Namely, the egg drippings and egg shells can be susceptible to salmonella contamination. These residual parts of the egg often drip on a stove top when the egg is cracked on the edge of the frying pan and/or on the table/countertop while cracking the egg on a bowl.

Other proposals have involved cookware for frying foodstuffs and disposing of the residue. The problem with these cooking devices and methods is that they do not provide an efficient place to catch residue, or cook and prepare the foodstuff, or both. Even though the above cited cookware meets some of the needs of the market, a cook-related assembly that provides a cookware, such as a frying pan, having an attached receptacle joined to a sidewall of the cookware for manipulating foodstuff, preparing foodstuff, cooking and warming a portion of the foodstuff, catching residue from the foodstuff, or combinations thereof is still desired.

### SUMMARY

Illustrative embodiments of the disclosure are generally directed to a cookware with attached receptacle assembly. The assembly is related to cooking and preparation of foodstuff. The assembly provides a cookware that is configured for cooking of foodstuff, and provides at least one receptacle that fixedly or detachably attaches along the sidewall of the cookware to provide multiple functions in conjunction with the cookware, including: manipulating the foodstuff, preparing the foodstuff, cooking or warming at least a portion of the foodstuff, catching residue from the foodstuff, or combinations thereof.

The cookware may include a frying pan, a sauce pan, bowl and a pot. The at least one receptacle may include a narrow receptacle or a wide receptacle, that can be used to cook food stuff, prepare foodstuff for cooking, and store foodstuff residue. The receptacle can span any percentage of the pan including full 360 degrees. The pan, pot, and bowl are not limited to a circular shape, it can include square, oval rectangle, etc.

In one embodiment, the cookware comprises an internal chamber defined by a base that is substantially flat or slightly concave. The flat base has an exterior surface and an interior surface. The exterior surface is adapted to be placed against a source of heat. The interior surface is adapted to have a foodstuff located thereon to be cooked by the source of heat the interior surface. The internal chamber is surrounded by a circumferential cookware sidewall, the cookware sidewall terminates at an upper free edge. In some embodiments, a handle extends from the upstanding sidewall.

The at least one receptacle either fixedly or detachably joins the cookware to operate in conjunction with the cookware in preparation and cooking of foodstuff, along with containing foodstuff residue. In its adjacent position to the cookware, the receptacle enables manipulation of foodstuff, preparation of foodstuff, cooking at least a portion of the foodstuff, and catching foodstuff residue during the preparations. It is significant to note that these multiple receptacle functions are performed in conjunction with the primary cooking functions of the cookware.

In one embodiment, the receptacle is wide. In another embodiment, the receptacle is narrow. In yet another embodiment, the cookware and the receptacle are fabricated from substantially the same material, such that heat transfers from the cookware to the receptacle, enabling the receptacle to cook foodstuff. In yet another embodiment, the cookware and the receptacle are fabricated from different materials, such that heat is inhibited from transferring from the cookware to the receptacle.

In some embodiments, the receptacle is defined by a continuous receptacle wall that forms a cavity and terminates at a receptacle edge. In joining with the cookware, the receptacle wall joins with the cookware sidewall. In one embodiment, the receptacle edge of the receptacle wall is generally coplanar with the upper free edge of the cookware sidewall. This allows the corresponding edges to be flush with each other. However in other embodiments, the free edge of the cookware and the receptacle edge of the receptacle are disposed at different elevations, such that the receptacle positions at a lower or higher elevation in relation to the cookware. The receptacle could also serve as a counterweight for the pan handle.

In some embodiments, the receptacle may fixedly join with the cookware, at a diametrically opposing point of the handle. In another embodiment, multiple receptacles may join with the cookware at different points along the cookware sidewall. In yet another embodiment, the receptacle detachably attaches to the cookware through a fastening mechanism. In yet another embodiment, the receptacle is configured to be slidably displaced along the free edge of the cookware, and then fastened at a desired position along the cookware sidewall.

In operation, the foodstuff is cooked primarily in the internal chamber on the interior surface of the cookware. Heat from the cookware transfers to the receptacle to enable smaller portions of food stuff to be cooked in the receptacle. For example, four eggs are scrambled in the cookware, and one egg is fried sunny-side-up in the receptacle.

Further, foodstuff may be prepared on the receptacle prior to cooking in the internal chamber of the cookware. For example, an egg is cracked on the junction of the receptacle edge of the receptacle and the free edge of the cookware sidewall. The contents of the shell are then transferred to the interior surface of the cookware for cooking.

Further, the residue from the foodstuff may be collected in the receptacle while cooking the foodstuff in the cookware. For example, after cracking an egg on the edges of the cookware and receptacle, the egg drippings are captured in the cavity of the receptacle as the egg is transferred to the interior surface for cooking. The egg shells may also be disposed in the cavity of the receptacle while cooking. After cooking the eggs, the contents of the receptacle may be discarded and cleaned along with the cookware.

One objective of the present invention is to provide an assembly that enables foodstuff to be cooked in a cookware, while providing an adjacent receptacle for manipulate foodstuff, preparing the foodstuff, cooking a portion of the foodstuff, catching residue from the foodstuff, or combinations thereof.

Another objective is to fixedly position the receptacle adjacent to the free edge of the cookware.

Yet another objective is to enable heat to transfer from the cookware to the receptacle, so as to enable cooking, heating or warming in the receptacle at a lower temperature.

Yet another objective is to enable the cookware to be slidably displaced along the free edge of the cookware, and then fastened at a desired position along the cookware sidewall.

Yet another objective is to provide a narrow and a wide receptacle, based on cooking needs and foodstuff residue content.

Yet another objective is to cook an egg in the cookware and catch the egg drippings after cracking the egg on the edges of the cookware and receptacle.

Yet another objective is to provide cookware that cooks foodstuff uniformly.

Yet another objective is to provide an inexpensive to manufacture cookware.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary cookware with attached multipurpose wide receptacle, in accordance with an embodiment of the present invention;

FIG. 2 illustrates a perspective view of cookware with attached multipurpose narrow receptacle, in accordance with an embodiment of the present invention;

FIG. 3 illustrates an elevated left side view of cookware with attached multipurpose narrow receptacle, in accordance with an embodiment of the present invention;

FIG. 4 illustrates an elevated left side view of cookware with attached multipurpose wide receptacle, in accordance with an embodiment of the present invention;

FIG. 5 illustrates a top view of an exemplary cookware with attached multipurpose wide receptacle, in accordance with an embodiment of the present invention;

FIG. 6 illustrates a rear view of an exemplary cookware with attached multipurpose wide receptacle, in accordance with an embodiment of the present invention;

FIG. 7 illustrates a bottom view of cookware with attached multipurpose wide receptacle, in accordance with an embodiment of the present invention;

FIG. 8 illustrates a frontal view of cookware with attached multipurpose wide receptacle, in accordance with an embodiment of the present invention;

FIG. 9 illustrates a top angle perspective view of cookware with attached multipurpose wide receptacle, in accordance with an embodiment of the present invention;

FIG. 10 illustrates a front bottom angle perspective view of cookware with attached multipurpose wide receptacle, in accordance with an embodiment of the present invention;

FIG. 11 illustrates a rear bottom angle perspective view of cookware with attached multipurpose wide receptacle, in accordance with an embodiment of the present invention;

FIG. 12 illustrates a perspective view of cookware with attached multipurpose wide receptacle, showing an unprepared foodstuff balanced at the junction between the periphery of the cookware and the wide receptacle, in accordance with an embodiment of the present invention;

FIG. 13 illustrates a top view of cookware with attached multipurpose wide receptacle, showing an unprepared foodstuff balanced at the junction between the periphery of the cookware and the wide receptacle, and a prepared foodstuff on a first surface of the cookware being cooked, in accordance with an embodiment of the present invention; and

FIG. 14 illustrates a left side view of cookware with attached multipurpose receptacle, showing foodstuff residue in the receptacle, in accordance with an embodiment of the present invention.

Like reference numerals refer to like parts throughout the various views of the drawings.

### DETAILED DESCRIPTION OF THE INVENTION

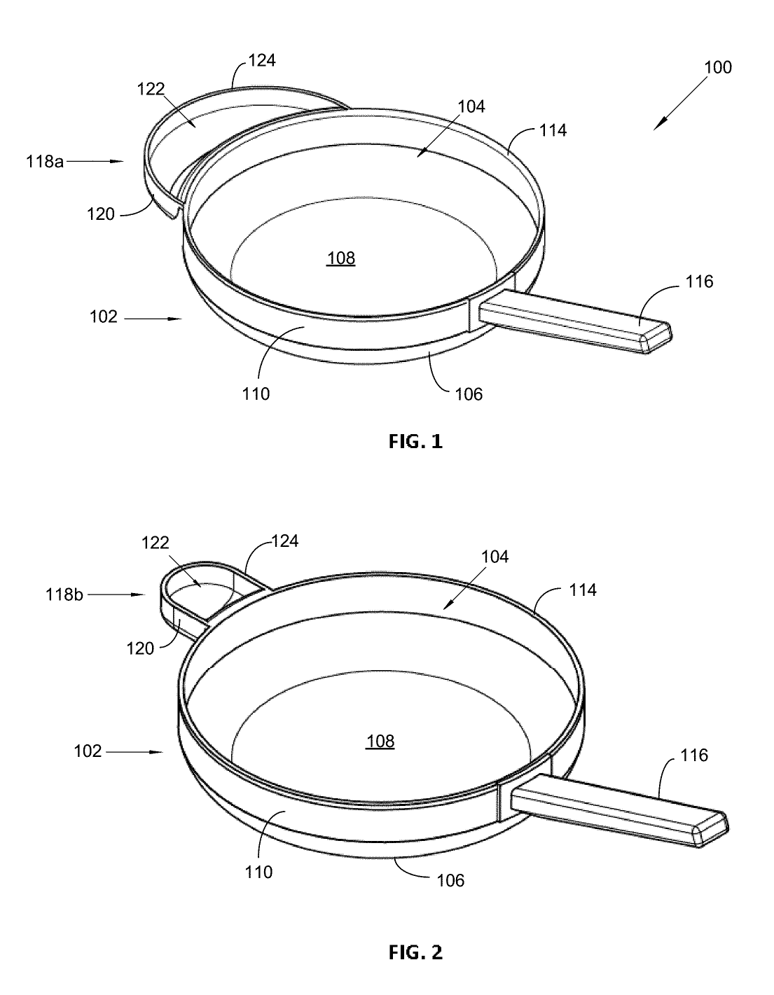

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A cookware with attached multipurpose receptacle assembly 100 is referenced in FIGS. 1-14. The assembly 100 is configured to enable efficient cooking and preparation of foodstuff 200, and also disposal of residue produced by the foodstuff 200. As shown in FIG. 1, assembly 100 provides a cookware 102 that is configured for preparation of foodstuff 200. Assembly 100 also provides at least one receptacle 118a, 118b that fixedly or detachably attaches along the sidewall 110 of the cookware 102 to help manipulate foodstuff 200, prepare foodstuff 200, cook a portion of the foodstuff 200, catch foodstuff residue 202, or combinations thereof.

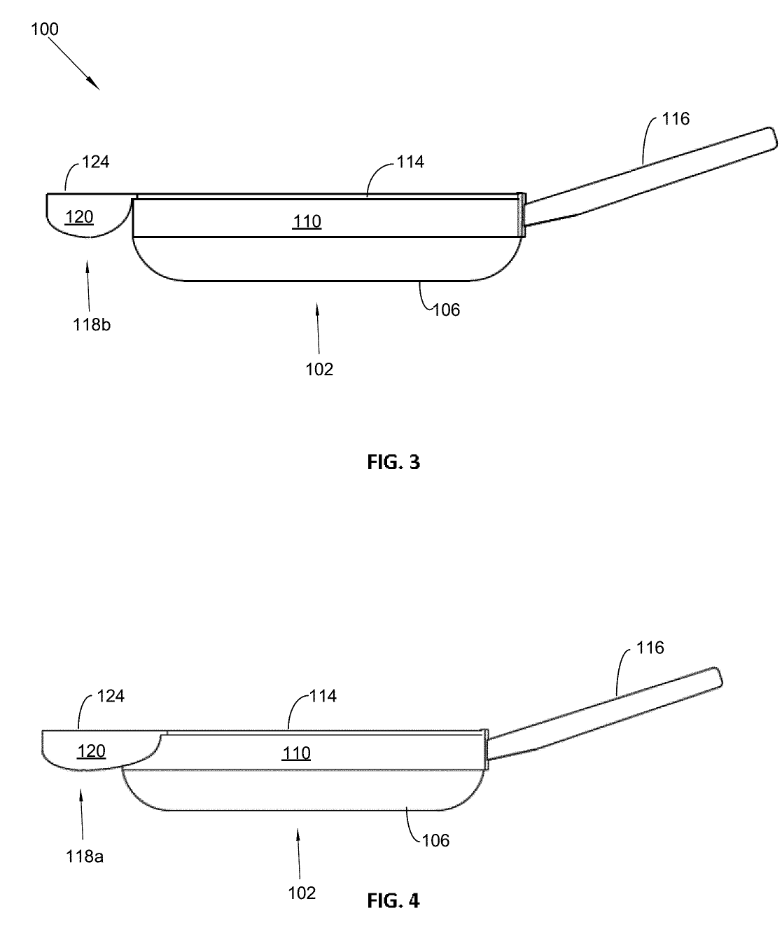

As FIG. 3 illustrates, cookware 102 may include, without limitation, a frying pan, a sauce pan, a bowl form for prepping scrambled eggs and a pot. Though in other embodiments, the cookware may include any food preparation container, commonly found in a kitchen and intended for use on a stove or range cooktop. Suitable materials for cookware 102 may include, without limitation, stainless steel, cast iron, anodized aluminum, carbon steel, and a metal alloy and the like. Cookware 102 is also made of any other suitable material such as ceramic. The handle attachment shown in the Fig.s is not necessary.

As illustrated in FIGS. 1 and 2, the receptacle may be wide 118a or narrow 118b, in relation to the periphery of the cookware sidewall 110. The dimensions of receptacle 118a, 118b may be determined by the requirements for foodstuff 200 preparation and the specific function of the receptacle 118a, 118b. Receptacle 118a, 118b may be fabricated from the same material as the cookware 102, whereby receptacle 118a, 118b may also be used for cooking in conjunction with the cookware 102.

However in other embodiments, receptacle 118a, 118b is fabricated from a different material composition than cookware 102, so as to insulate receptacle 118a, 118b from heat in the cookware 102. In any case, cookware 102 and receptacle 118a, 118b create a synergy that enables efficient manipulation of foodstuff 200, preparation of foodstuff 200, cooking of foodstuff 200, catching foodstuff residue 202, or combinations thereof.

In one exemplary embodiment, foodstuff 200 is an egg, and foodstuff residue 202 is the egg dripping and egg shells. The egg may be cracked on the edges of the cookware 102 and receptacle 118a, 118b, cooked in the cookware 102, and the residue placed in the receptacle 118a, 118b. Though in other embodiments, other types of foodstuff 200 may be prepared, cooked, and disposed of in the assembly 100.

Looking now at FIG. 4, cookware 102 comprises an internal chamber 104 defined by a substantially flat base 106. Though in other embodiments, the base 106 may have a slightly concave shape. Base 106 has an exterior surface 112 and an interior surface 108. Exterior surface 112 of base 106 is adapted to be placed against a source of heat, such as a stove top. Interior surface 108 of base 106 is adapted to have a foodstuff 200 located thereon to be cooked by the source of heat the interior surface 108. In some embodiments, base 106 may be metallic to enable heat to be conducted from the exterior surface 112 to the interior surface 108.

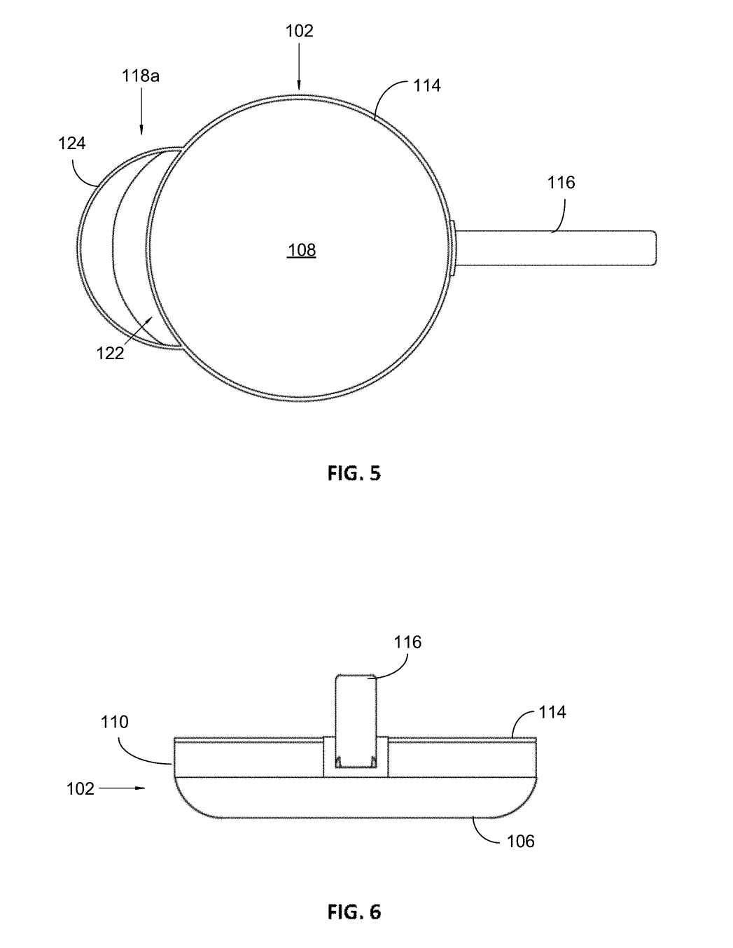

As referenced in FIG. 5, internal chamber 104 of cookware 102 has a generally concave shape that is efficacious for containing foodstuff 200 during cooking functions. Internal chamber 104 may be deep or shallow, depending on the cooking requirements. As FIG. 6 shows, internal chamber 104 is surrounded by a circumferential cookware sidewall 110. The sidewall is substantially the same material as base 106, such that heat transfers uniformly from the base 106 to the cookware sidewall 110. Cookware sidewall 110 terminates at an upper free edge 114. Free edge 114 follows the peripheral path of cookware sidewall 110 around the base 106.

Looking at FIG. 7, free edge 114 may be sharp to enable cracking of an egg. In some embodiments, a handle 116 extends from the upstanding sidewall. Handle 116 may have a rubber coating to protect against heat transfer from the base 106 and cookware sidewall 110. Handle 116 may also be elongated. In some embodiments, two short handles may attach to cookware sidewall 110.

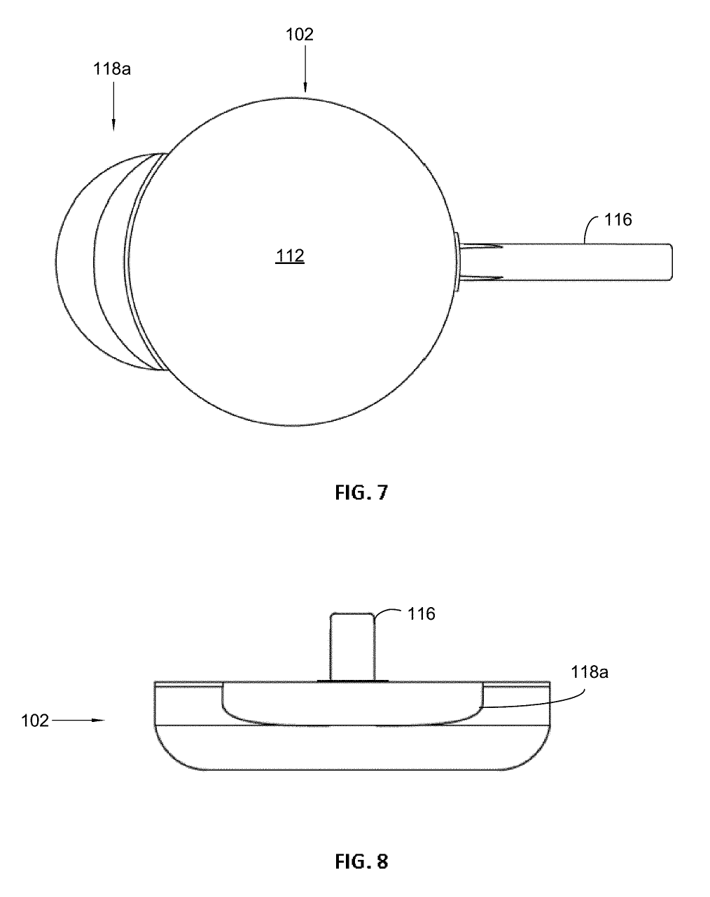

As referenced in FIG. 8, at least one receptacle 118a, 118b joins cookware 102. Receptacle 118a, 118b is configured to enable the manipulation of foodstuff 200, preparation of foodstuff 200, cooking a portion of the foodstuff 200, and catching foodstuff residue 202. In this manner, receptacle 118a, 118b functions are performed in conjunction with the primary cooking functions of cookware 102. For example, foodstuff residue 202 is conveniently placed in adjacent receptacle 118a to cookware 102; whereby residue 202 can include egg drippings and eggshells.

Turning now to FIG. 9, receptacle 118a, 118b is defined by a continuous receptacle wall 120 forming a cavity 122. Cavity 122 is sufficiently deep to contain residue or cook foodstuff 200. Receptacle wall 120, similar to the cookware sidewall 110, terminates at a receptacle edge 124. In joining with the cookware 102, the receptacle wall 120 joins with the cookware sidewall 110.

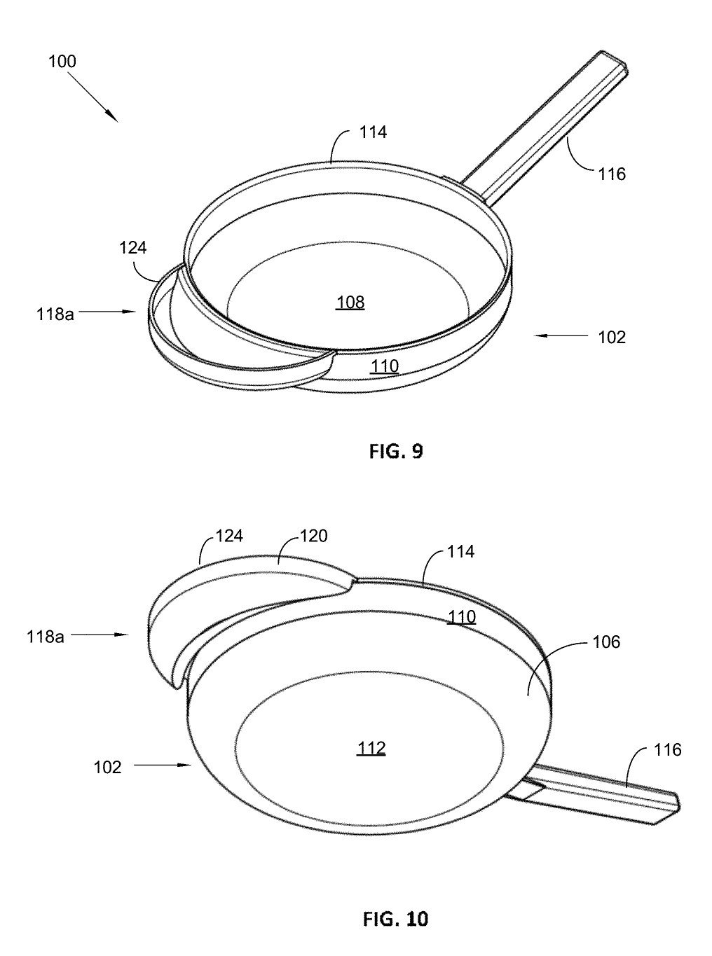

As illustrated in FIG. 10, the receptacle edge 124 of receptacle wall 120 is generally coplanar with the upper free edge 114 of cookware sidewall 110. This allows the corresponding edges to be flush with each other. However in other embodiments, free edge 114 of the cookware 102 and receptacle edge 124 of the receptacle 118a, 118b are disposed at different elevations, such that receptacle 118a, 118b positions at a lower or higher elevation in relation to cookware 102.

Looking back at FIGS. 1 and 2, receptacle 118a, 118b can have two embodiments, with a first embodiment having a wide receptacle 118a in relation to the cookware sidewall 110, and a second embodiment having a narrow receptacle 118b in relation to the cookware sidewall 110. The wide receptacle 118a has a generally longer receptacle wall 120 that extends around at least 15% of the circumference of the cookware sidewall 110 (FIGS. 2 and 4). The narrow receptacle 118b has a receptacle wall 120 that is generally less than 15% of the circumference of cookware sidewall 110. However, the narrow receptacle 118b may be longer, extending outwardly from the cookware sidewall 110 (FIGS. 1 and 3).

In yet another embodiment, cookware 102 and receptacle 118a, 118b are fabricated from substantially the same material, such that heat transfers from cookware 102 to receptacle 118a, 118b. This enables receptacle 118a, 118b to cook foodstuff 200 in the cavity 122 of receptacle 118a. In yet another embodiment, cookware 102 and receptacle 118a are fabricated from different materials, such that heat is inhibited from transferring from the cookware 102 to the receptacle 118a. This can be useful when receptacle 118a is used primarily to contain food residue.

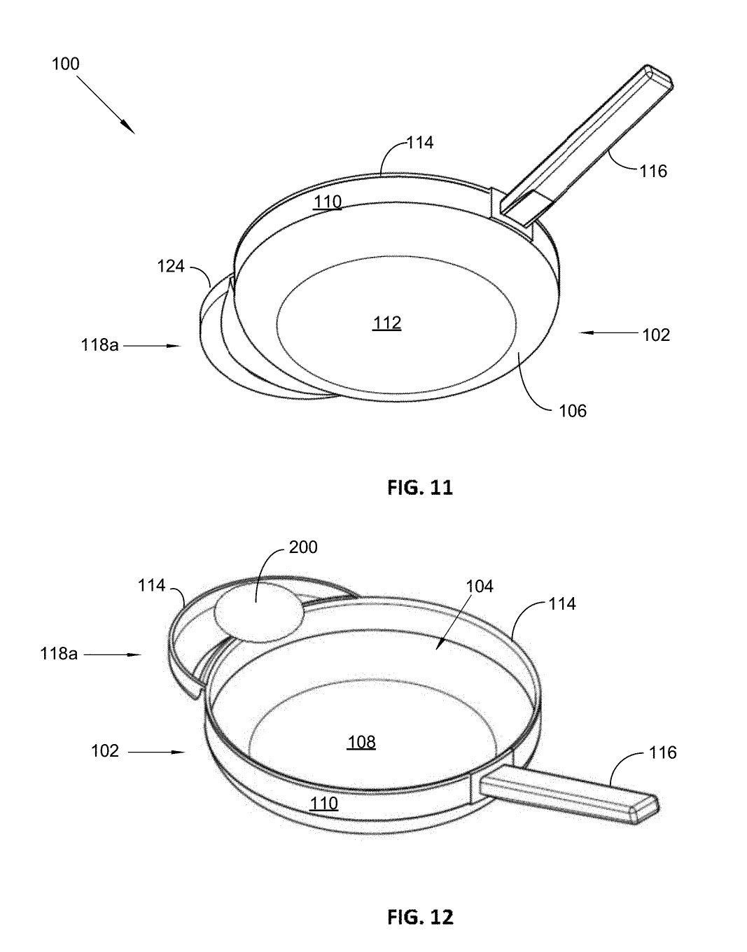

Looking now at FIG. 11, receptacle 118a may fixedly join with cookware 102, at a diametrically opposing point of handle 116. In this manner, receptacle 118a does not obstruct manipulation of cookware 102 with handle 116. In another embodiment, multiple receptacles may join with the cookware 102 at different points along cookware sidewall 110. In this manner, a first receptacle is used for cooking, a second receptacle is used for collecting residue. When multiple receptacles are used, one may be narrow and the other may be wide.

In yet another embodiment, receptacle 118a detachably attaches to cookware 102 through a fastening mechanism. Various fastening mechanisms may be used to detachably fasten the receptacle 118a to the cookware 102. The fastening mechanisms may include a slot in the cookware sidewall 110 that couples to a protrusion from receptacle wall 120. Other fastening mechanisms may include a magnet, a bolt, and a friction fit mechanism.

In yet another embodiment, the receptacle 118a is configured to be slidably displaced along the free edge 114 of cookware 102, and then fastened at a desired position along the cookware sidewall 110. In this embodiment, receptacle wall 120 may have a channel that rides free edge 114 of cookware sidewall 110. Once the receptacle 118a is displaced to a desired position along the cookware sidewall 110, the fastening mechanism secures the receptacle 118a in place.

In some embodiments, free edge 114 of cookware 102 and receptacle edge 124 of the receptacle 118a are substantially coplanar. Thus, the cookware 102 and the receptacle 118a are flush with each other. As FIG. 12 illustrates, the coplanar edges 114, 124 can support or work together to crack an egg.

However in other embodiments, free edge 114 of the cookware 102 and receptacle edge 124 of receptacle 118a are disposed at different elevations. Thus, receptacle 118a may be higher or lower than cookware 102. When receptacle 118a is lower than cookware 102, the receptacle 118a is generally used to catch foodstuff residue 202 since gravity carries the residue into the cavity 122 of the receptacle 118a. When the receptacle 118a is higher than cookware 102 and disengaged from the heat source, the receptacle 118a is also used to catch foodstuff residue 202.

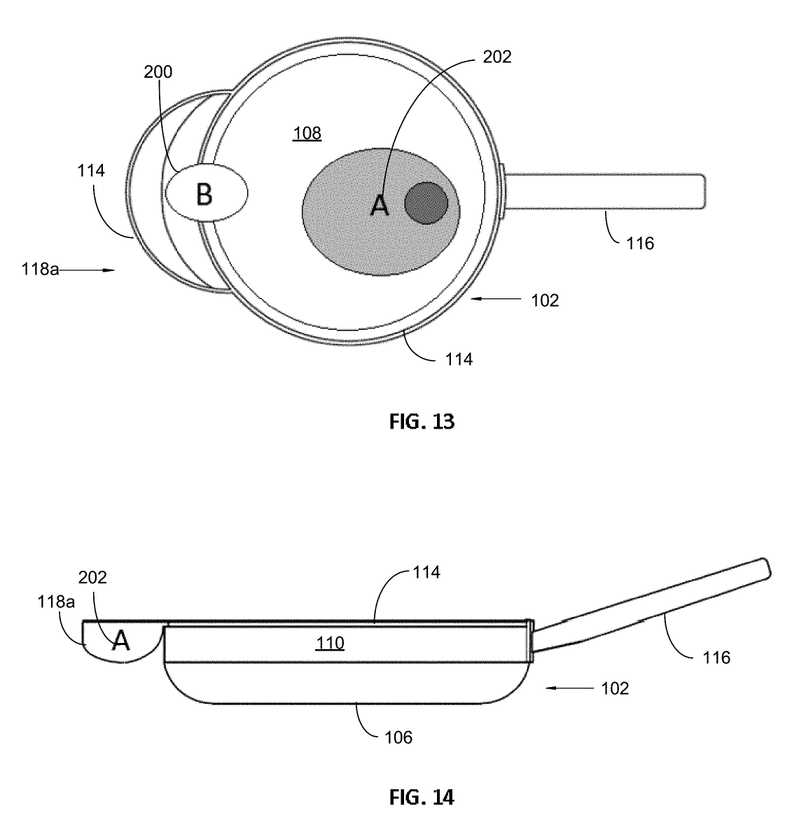

In another operational embodiment illustrated in FIG. 13, foodstuff 200 is cooked primarily in the internal chamber 104 on interior surface 108 of cookware 102. Heat from cookware 102 transfers to receptacle 118a to enable smaller portions of food stuff to be cooked in receptacle 118a. The temperature of a stovetop or fire source may be adjusted to achieve a desired cooking temperature on the interior surface 108. In some embodiments, interior surface 108 is also coated with a nonstick agent to inhibit sticking of foodstuff 200.

As discussed above, the heat from cookware 102 transfers to receptacle 118a. This is especially effective when cookware 102 and the receptacle 118a are substantially the same material. For example, four eggs are cooked in the cookware 102, and one egg is fried sunny-side-up in the receptacle 118a. Or in another embodiment, a meat is cooked in cookware 102 and a side vegetable is cooked in receptacle 118a. However, any combinations of foodstuffs may be cooked between the cookware 102, or receptacle 118a, or both.

In another operational embodiment illustrated in FIG. 12, the foodstuff 200 may be prepared on receptacle 118a prior to cooking in the internal chamber 104 of cookware 102. The preparation may include dismembering outer shells of the food to access the edible components. For example, an egg is cracked on the junction of the receptacle edge 124 of the receptacle 118a and free edge 114 of the cookware sidewall 110. The eggshell may also be cracked on the free edge 114 of cookware 102, or the receptacle edge 124 of receptacle 118a. Once cracked, the yolk and the egg white may then be transferred to interior surface 108 of cookware 102, or cavity 122 of receptacle 118a or both, for cooking.

In yet another operational embodiment illustrated in FIG. 14, the foodstuff residue 202 is contained in receptacle 118a, while foodstuff 200 is cooked in cookware 102. In this embodiment, receptacle 118a serves to catch residue or store residual waste from the foodstuff 200 while cooking the foodstuff 200 in the cookware 102. For example, after cracking an egg on the edges of cookware 102 and receptacle 118a, the egg drippings the egg shells are carried over the receptacle 118a and the egg drippings and egg shells are captured in cavity 122 of the receptacle 118a. Further, as the egg white and egg yolk are transferred to interior surface 108 for cooking, the egg drippings can matriculate into receptacle 118a. In yet another operational embodiment, the egg shells may be disposed in the cavity 122 of receptacle 118a, 118b while cooking the egg white and egg yolk. After cooking the eggs, the contents of receptacle 118a may be discarded and cleaned along with cookware 102.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A cookware device with attached multipurpose receptacle assembly, the assembly comprising:
a cookware comprising an internal chamber, the internal chamber defined by a substantially flat base, the base having an interior surface and an exterior surface, the internal chamber surrounded by a circumferential upstanding cookware sidewall, the cookware sidewall having an upper free edge, the exterior surface adapted to be placed against a source of heat, the interior surface adapted to have a foodstuff located thereon to be cooked by the source of heat;
a handle extending from the cookware sidewall; and
a receptacle comprising a continuous receptacle wall, the receptacle wall defined by a cavity and terminating at a receptacle edge, the receptacle wall disposed to join with the cookware sidewall, whereby the receptacle edge of the receptacle wall is generally coplanar with the upper free edge of the cookware sidewall.

2. The assembly of claim 1, wherein the cookware is a frying pan.

3. The assembly of claim 1, wherein the internal chamber has a generally concave shape.

4. The assembly of claim 1, wherein the base has a generally round shape.

5. The assembly of claim 1, wherein the cookware is fabricated from at least one of the following: stainless steel, cast iron, anodized aluminum, carbon steel, ceramic and a metal alloy.

6. The assembly of claim 1, wherein the receptacle is wide or narrow.

7. The assembly of claim 1, wherein the material fabrication of the cookware is substantially the same as the material fabrication of the receptacle.

8. The assembly of claim 1, wherein the free edge of the cookware and the receptacle edge of the receptacle are substantially coplanar.

9. The assembly of claim 1, wherein the free edge of the cookware and the receptacle edge of the receptacle are disposed at different elevations.

10. The assembly of claim 1, wherein the receptacle wall fixedly joins with the cookware sidewall.

11. The assembly of claim 1, wherein the receptacle wall detachably attaches to the cookware sidewall.

12. The assembly of claim 1, wherein the receptacle is configured to be slidably displaced along the free edge of the cookware.

13. The assembly of claim 1, wherein the foodstuff is an egg.

14. A cookware with attached multipurpose receptacle assembly, the assembly comprising:
a cookware comprising an internal chamber, the internal chamber defined by a base, the base having an interior surface and an exterior surface, the internal chamber surrounded by a circumferential upstanding cookware sidewall, the cookware sidewall having an upper free edge; and
a receptacle comprising a continuous receptacle wall, the receptacle wall defined by a cavity and terminating at a receptacle edge, the receptacle wall disposed to join with the cookware sidewall, whereby the receptacle edge of the receptacle wall is generally coplanar with the upper free edge of the cookware sidewall.

15. The assembly of claim 14, further comprising a handle extending from the cookware sidewall.

16. The assembly of claim 14, wherein the receptacle wall fixedly joins with the cookware sidewall.

17. The assembly of claim 14, wherein the receptacle wall detachably attaches to the cookware sidewall.

18. The assembly of claim 14, wherein the receptacle is configured to be slidably displaced along the free edge of the cookware.

19. The assembly of claim 14, wherein the exterior surface is adapted to be placed against a source of heat.

20. The assembly of claim 14, wherein the interior surface is adapted to have a foodstuff located thereon to be cooked by the source of heat.
